(19) United States
(12) Patent Application Publication
(10) Pub. No.: US 2024/0104424 A1
(43) Pub. Date: Mar. 28, 2024

(54) ARTIFICIAL INTELLIGENCE WORK CENTER

(71) Applicant: SAP SE, Walldorf (DE)

(72) Inventors: Mohit V. Gadkari, Bangalore (IN); Ankur Malik, Bangalore (IN); Sunil S. Parvatikar, Bangalore (IN); Simona Marincei, Rauenberg (DE); Dalibor Knis, Stupava (SK); Anirudh Prasad, Sandhausen (DE); Kopal Jauhari, Bengaluru (IN); Saurabh Saxena, Bengaluru (IN); Yatish Nagaraja, Bengaluru (IN); Pankaj Kumar Agrawal, Bangalore (IN); Long Qian, Shanghai (CN); Varun Verma, Bangalore (IN)

(21) Appl. No.: 17/952,107

(22) Filed: Sep. 23, 2022

(51) Int. Cl. G06N 20/00

(52) U.S. Cl. CPC G06N 20/00

(57) ABSTRACT

The present disclosure involves systems, software, and computer implemented methods for an artificial intelligence work center for ERP data. One example method includes receiving scenario and model settings for an artificial intelligence model for a predictive scenario. A copy of the dataset is processed based on settings to generate a prepared dataset that is provided with the settings to a predictive analytical library. A trained model trained and evaluation data for the trained model is received from the predictive analytical library. A request is received to generate a prediction for the predictive scenario for a target field for a record of the dataset. The record of the dataset is provided to the trained model and a prediction for the target field for the record the dataset is received from the model. The prediction is included for presentation in a user interface that displays information from the dataset.

### TECHNICAL FIELD

The present disclosure relates to computer-implemented methods, software, and systems for an artificial intelligence work center for ERP (Enterprise Resource Planning) data.

### BACKGROUND

An ERP system can be used by an organization for integrated management of organizational processes. The ERP system can include a database that can store objects that are used in numerous, core processes of the organization. Some processes that can be managed by an ERP system include resource tracking, payroll, sales orders, purchase orders, and invoicing, to name a few examples.

### SUMMARY

The present disclosure involves systems, software, and computer implemented methods for an artificial intelligence work center for ERP (Enterprise Resource Planning) data. Although ERP data is described, the artificial intelligence center can be used for other types of data. An example method includes: receiving scenario settings for a predictive scenario for a target field of a dataset; receiving model settings for at least one artificial intelligence model for the predictive scenario; and for a first model of the at least one artificial intelligence model: combining the scenario settings and model settings for the first model to generate first model parameters for the first model; processing a copy of the dataset based on the first model parameters to generate a prepared dataset; providing the prepared dataset and the first model parameters to a predictive analytical library that is configured to build, train, and test artificial intelligence models; receiving, from the predictive analytics library, a reference to a first trained artificial intelligence model trained by the predictive analytical library based on the prepared dataset and the first model parameters and first model evaluation data that reflects model performance of the first model for predicting the target field of the dataset; receiving a request to activate the first model for the predictive scenario; receiving a request to generate a prediction for the predictive scenario for the target field for at least one record of the dataset; providing the at least one record of the dataset to the first trained artificial intelligence model; receiving, from the first trained artificial intelligence model, a prediction for the target field for each record of the at least one record of the dataset; and providing at least one prediction for presentation in a user interface that displays information from the dataset.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for an artificial intelligence work center for ERP (Enterprise Resource Planning) data.

FIG. 2 is a diagram that illustrates a process flow for an artificial intelligence work center.

FIG. 3 illustrates a user interface for editing or creating a scenario.

FIG. 4 illustrates a user interface for data pre-processing settings for scenarios.

FIG. 5 illustrates a user interface for training settings for scenarios.

FIGS. 6 and 7 illustrate scenario list user interfaces.

FIG. 8 illustrates a user interface for creating or editing a model.

FIG. 9 illustrates a user interface for data filtering settings for a model.

FIG. 10 illustrates a user interface for nulls removal settings for a model.

FIG. 11 illustrates a user interface for outlier removal settings for a model.

FIG. 12 illustrates a user interface for training settings for a model.

FIG. 13 illustrates a user interface for training status for a model.

FIG. 14 illustrates a model list user interface.

FIG. 15 illustrates a user interface for editing or creating a prediction run

FIG. 16 illustrates a prediction run list user interface.

FIG. 17 is a diagram that illustrates consumption of a machine learning prediction.

FIG. 18 is a user interface that illustrates consumption of a machine learning prediction.

FIG. 19 is a flowchart of an example method for using a machine learning work center for ERP data.

### DETAILED DESCRIPTION

Artificial Intelligence (AI) algorithms are intelligent algorithms that can be applied in different contexts, such as ERP systems. Machine learning (ML) algorithms can be referred to as a subset of AI technology. Although some specific examples and terminology below may refer to ML, the methods and systems described herein can be applied to any AI or ML algorithm or model. Additionally, although some examples below refer to ERP systems and/or ERP data, the methods and systems described herein can be applied in general with respect to other types of software system providers and customers of the software system provider

Users of an ERP system may want to incorporate machine learning (ML) or Artificial Intelligence (AI) with use of the ERP system. For example, the ERP system may support an object that represents an opportunity for an organization. Users of the ERP system may be interested in ML predictions regarding whether certain opportunities are likely to be won or lost. As another example, organizations may classify customers according to tiers, such as gold, silver, platinum, etc. Users may desire to know ML predictions for a new customer as to what an eventual likely tier may be. Or using ML to recommend the best supplier for a particular product or service as well as predicting the delivery time for it.

Users of an ERP system can export ERP data from the ERP system and import the exported data which can be previously cleaned up and pre-processed into an external tool that is capable of training ML/AI algorithms with those data items and return the desired outcome (prediction, classification, recommendation, etc.). Then, once the AI/ML outcome is available in that tool the users of the ERP systems can import and integrate AI/ML outcome back into their ERP system where ERP processes can make use of it. However, data export and import, data clean up, and backward integration of results may be resource-intensive, and possibly error-prone, and the users would also need to learn and understand the capabilities of the external tool. For example, some ERP systems may include a predictive analytics library or connection to other AI tooling. However, the included predictive analytics library or AI tooling may be geared towards programmers, data scientists, and/or database technology experts. Accordingly, ERP users who do not have such programming, data science, ML, or other deep technical knowledge cannot simply use such an embedded predictive analytics library. Rather, end users or subject matter experts are generally reliant on other technical users' knowledge to implement ML functionality into ERP processes, which may come at a considerable time and cost expense.

To shield ERP users from technical complexity of an AI/ML algorithm usage and offer an end-to-end integrated user experience, the ERP system can be adapted to include a AI/ML, work center as a front-end component of the ERP system. The ML work center can be a front-end for the internal or external predictive analytics library or AI tool. The ML work center can provide an intuitive console for ERP users to define and manage AI/ML models without requiring detailed knowledge of ML or the respective AI tools used for it.

For example, the ML work center can provide a framework and tools to model machine learning scenarios, prepare data, build and train ML models, and evaluate predictive performance of the trained ML models. ML scenarios can represent predictive objectives for ERP ML use and ML models can be realizations of the ML scenarios. The ML work center can guide users though ML workflows and assist in model fine-tuning and best practices. The ML work center can provide a framework to call the AI/ML algorithms to train the AI/ML models and to use trained AI/ML models to generate predictions. The ML work center can enable users to embed predictions in ERP documents, user interfaces (e.g., of ERP objects for which predictions are made), analytic reports, and KPI's (Key Performance Indicators). For instance, the ML work center can enable easy integration of resulted ML predictions (classifications, recommendations, regressions, etc.) within ERP processes using, for example, existing ERP extensibility capabilities.

Accordingly, the ML work center can enable customers access to ML scenarios without previous ML, data science, or programming knowledge. The ML work center can shield users from the complexity of an AI algorithm implementation and offer an easy to use interface with reasonably selected and best practice configuration options and the flexibility to adapt them on going through experimentation. Accordingly, users can focus on an ERP context of the ML scenarios rather than technical intricacies of ML, data science, or the internal predictive analytics library itself. As such, the ML work center can provide a “ML for everyone” tool, by providing a tool that bridges a gap between technical ML details by enabling ERP users such as ERP data analysts access to ML workflows.

The ML work center can provide specific features and benefits to various types of ERP user personas. For example, for ERP end users, the ML work center can enable the ERP end users to make better and faster organizational decisions. For instance, predictions embedded in organizational objects or documents can assist in faster, more informative organizational decisions, as compared to use of such documents or objects that don't have embedded prediction information. For example, predictive analytical reports and KPI's that include ML prediction information can assist ERP decision makes by providing deeper predictive insight (sales prediction, discount and pricing prediction, etc.).

As mentioned, ERP analytics expert users can use the ML work center to create new predictive scenarios, train and evaluate ML models to implement the scenarios, and create prediction runs to generate predictions for the scenarios. The analytics expert users can use the ML work center to enrich intelligent scenarios with custom extensions, use prediction results in analytical reports, and/or fine-tune existing or new ML models. As another example, the analytics expert can create extension fields to an ERP object and use the extension fields in custom predictive scenarios based on ERP system customer needs (e.g., predict the chance of winning or losing an opportunity and embed that information as an extension field in the ERP opportunity object for the use of the sales agent owning that opportunity).

The ML work center can enable partner developers to create new custom objects that are used in new predictive scenarios. As another example, partner developers can create extensions to standard objects which will be used in predictive scenarios Partner developers can create or modify data sources that can then later be used in predictive scenarios that are configured using the ML work center. Partners can deploy custom, ML-enabled objects, extensions and data sources to ERP customers.

The ML work center can support various roles for enabling appropriate security. For example, a scenario administrator may have privileges to create ML scenarios but not to train ML models or create predictions. A model trainer may have privileges to create models for scenarios to which the ML trainer has read data access, but not an ability to edit the scenarios or create scenarios for data objects for which they have no read permission. A prediction run creator may be granted an ability to create prediction runs based on active (e.g., trained) models of scenarios to which the prediction run creator has access, but not an ability to train the ML models or edit or create scenarios. ERP customers or end users may have access to view prediction results but not access to modify or create new ML work center objects.

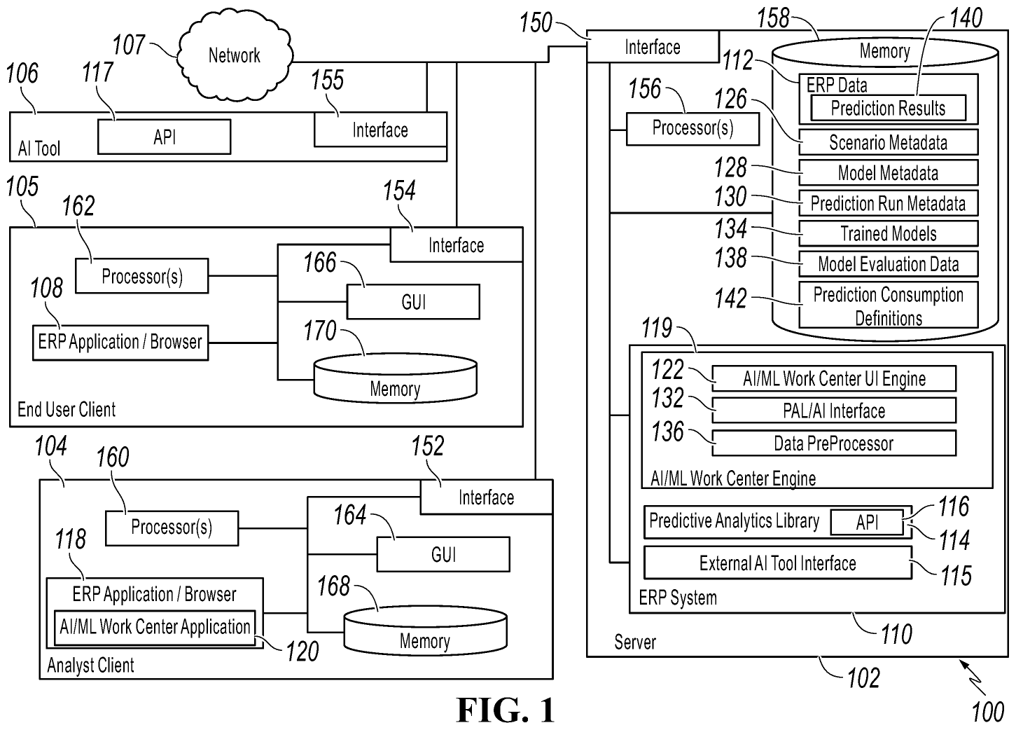

FIG. 1 is a block diagram illustrating an example system 100 for creating and merging delta object notation documents. Specifically, the illustrated system 100 includes or is communicably coupled with a server 102, an analyst client device 104, an end-user client device 105, an external AI tool 106, and a network 107. Although shown separately, in some implementations, functionality of two or more systems or servers may be provided by a single system or server. In some implementations, the functionality of one illustrated system or server may be provided by multiple systems or servers.

An end user can use the end-user client device 105 to access an ERP application 108 (which may be an installed application or a web browser displaying an ERP web page application). The ERP application 108 can be provided by an ERP system 110 (which may be provided by the server 102 and/or multiple servers). The ERP application 108 may enable the end user to perform actions on ERP data 112. The ERP system 110 can include or otherwise be associated with memory 158 that includes the ERP data 112 and other information, as described below.

The ERP system 110 includes a predictive analytics library 114 that enables machine learning functionality and/or may connect to the external AI tool 106 using an interface 115. As end users likely do not have the required computer programming and/or data science skills necessary to understand and use an API (Application Programming Interface) 116 of the predictive analytics library 114 or an API 117 of the external AI tool 106, an integrated PAL/AI Interface 132 of the AI/ML work center engine 119 can be used to connect the AI/ML work center engine 119 on behalf of the end user through the API 116 or 117.

An analyst can use the analyst client device 104 to access the ERP system 110 (e.g., using an ERP application 118 (which may be a browser or an installed application). The ERP application 118 used by the analyst can offer features not available to the end user, such as an ability to create reports, create extension fields, etc., for use by end users such as the end user of the end-user client device 104. The analyst may desire to leverage the capability of the predictive analytical library 114, such as to include machine learning outputs (e.g., predictions) in user interfaces, reports, etc., that are used by the end user. However, the analyst may also not have the required computer programming and/or data science skills (as well as the time and budget) necessary to use the PAL 114 or the external AI tool 106.

To enable the analyst (and other users of the ERP system 110) to leverage AI/ML functionality of the predictive analytics library 114 or the external AI tool 106 without leaving their ERP system 110 and without requiring advanced computer programming, database programming, or data science skills, the AI/ML work center engine 119 included in the ERP system can provide (e.g., as part of the ERP application 118), a AI/ML work center application 120 that guides the analyst to use functionality of the predictive analytics library 114 included in the ERP system 110. As mentioned, although an internal PAL 114 is described, the AI/ML work center engine 119 can integrate with an external ML tool such as the external AI tool 106 in some implementations.

The AI/ML work center application 120 can include various user interfaces (UIs) that are provided by a AI/ML work center UI engine 122 of the AI/ML work center engine 119. For example, the AI/ML work center UI engine 122 can provide, in the AI/ML work center application 120, various user interfaces for recommending, prompting for, and receiving predictive scenario metadata 126, model metadata 128, prediction run metadata 130, as well as data cleaning and pre-processing (including filtering, null removals, outlier removals, etc.) to be used in a machine learning workflow that leverages the predictive analytics library 114.

The predictive scenario metadata 126 can define predictive scenarios that the analyst (or another user) wants to build. A scenario represents a definition of a predictive objective and data structure to be used to achieve the predictive objective. For example, the analyst may want to add functionality to ERP interfaces or applications that involve opportunity documents to include data that indicates whether a given opportunity is expected to be won or lost for the customer of the ERP system 110. The predictive scenario metadata 126, as obtained using the AI/ML work center application 120, can include information that identifies which analytical data source in the ERP data 112 will be used for predictions and which data source field represents the predictive objective. For instance, for opportunities, a lifecycle status field may store values indicating whether respective opportunities are won or lost. The scenario metadata 126 also includes default parameter values for machine learning models that may be used to realize the scenario. A given scenario can have one or more models.

The model metadata 128, as obtained using the AI/ML work center application 120 using guided processes, can define machine learning model(s) to be used to realize the predictive scenario. A predictive scenario can represent a problem to be solved and each model can represent a potential solution to the problem. Model metadata 128 for a given model can initially include default data from the predictive scenario 126 for some parameters, but the analyst can modify certain parameters for a given model using the AI/ML work center application 120.

The model metadata 128 for a model can include parameters that are used by the predictive analytics library 114 to train the model. The AI/ML work center engine 119 can provide the model metadata 128 to the predictive analytics library 114 by using the API 116. The PAL 114 can build and train model(s), based on the model metadata 128, to generate trained models 134. For a given model, the PAL 114 can provide a reference to the corresponding trained model 134 to the AI/ML work center engine 119.

The PAL 114 or external AI tool 106 can include an extensive set of AI/ML algorithms of different types. As mentioned, the PAL 114 and the external AI tool 106 can be complex and the APIs 116/117 can each require both programming and data science expertise. The PAL 114 can include features for clustering, classification, regression, time series, feature engineering, parameter optimization, and other features. The AI/ML work center engine 119 can be configured to invoke the API 116 and/or the API 117 as appropriate, to request training of models per the model metadata 128 received using the AI/ML work center application 120.

A model can be pre-processed before being trained. For example, the model metadata 128 can include data pre-processing parameters. Data pre-processing is an important part of model building and can be performed by a data pre-processor 136 to identify and cure data quality issues such as null and outlier values. Proper data pre-processing by the data pre-processor 136 can help to improve the quality of resulting trained model.

The PAL 114 can provide, to the AI/ML work center engine 119, model evaluation data 138 that describes, for a given model, how accurately the model makes predictions for the predictive scenario. The AI/ML work center application 120 can present model evaluation data for multiple models of a scenario, so that the analyst can consider and select a model to use for the scenario. The AI/ML work center application 120 can enable the analyst to activate a selected model for the scenario, for example. An active model can be used to generate a prediction for the predictive scenario dataset, such as for new or modified records. Predictions can be managed by the AI/ML work center engine 119 based on the prediction run metadata 130 and the active model.

The prediction run metadata 130 can include mass data run objects that include data defining generation of a prediction using an active model of a scenario. The prediction run metadata 130 can include scheduling information that defines a schedule of generating predictions, for example. Prediction runs can include prediction specific filter conditions that can define which data of the scenario data source for which the active model generates predictions.

The AI/ML work center engine 119 can request the PAL to generate predictions, based on the prediction run metadata 130, using the PAL interface 132. Generated predictions can be stored as prediction results 140. The prediction run metadata 130 can specify which data source data fields are to store the prediction results, for example. In some cases, the prediction results 140 are extension fields, such as of the data source for which the prediction is made.

The analyst or a customer or partner developer can, for example, specify different types of prediction consumption definitions 142 for consumption of the prediction results. For example, different user interfaces, such as a UI that displays data for the predictive scenario data source (e.g., a UI that shows opportunity data) can be modified to display the prediction results (e.g., modified to include an extension field that stores prediction results). Other examples include reports or other types of user interfaces, such as those that may include an embedded control that displays prediction results, as described in more detail below.

As used in the present disclosure, the term “computer” is intended to encompass any suitable processing device. For example, although FIG. 1 illustrates a single server 102, a single analyst client device 104, and a single end-user client device 105, the system 100 can include multiples of such devices. Additionally, the server 102, for example, may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102, the analyst client device 104, and the end-user client device 105 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 150, 152, 154, and 155 are used by the server 102, the analyst client device 104, the end-user client device 105, and the external AI tool 106, respectively, for communicating with other systems in a distributed environment—including within the system 100—connected to the network 107. Generally, the interfaces 150, 152, 154, and 155 each comprise logic encoded in software and/or hardware in a suitable combination and operable to communicate with the network 107. More specifically, the interfaces 150, 152, 154, and 155 may each comprise software supporting one or more communication protocols associated with communications such that the network 107 or interface's hardware is operable to communicate physical signals within and outside of the illustrated system 100.

The server 102 includes one or more processors 156. Each processor 156 may be a central processing unit (CPU), a blade, an application specific integrated circuit (ASIC), a field-programmable gate array (FPGA), or another suitable component. Generally, each processor 156 executes instructions and manipulates data to perform the operations of the server 102. Specifically, each processor 156 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Peri®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 includes memory 158. In some implementations, the server 102 includes multiple memories. The memory 158 may include any type of memory or database module and may take the form of volatile and/or non-volatile memory including, without limitation, magnetic media, optical media, random access memory (RAM), read-only memory (ROM), removable media, or any other suitable local or remote memory component. The memory 158 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102.

The analyst client device 104 and the end-user client device 105 may each generally be any computing device operable to connect to or communicate with other devices via the network 107 using a wireline or wireless connection. The analyst client device 104 and the end-user client device 105 can each include one or more client applications, including the ERP application 118 or the ERP application 108, respectively. In general, a client application is any type of application that allows the analyst client device 104 or the end-user client device 105 to request and view content on the respective device. In some implementations, a client application can use parameters, metadata, and other information received at launch to access a particular set of data from the server 102. In some instances, a client application may be an agent or client-side version of the one or more enterprise applications running on an enterprise server (not shown). Although referred to as an analyst client device 104 for purposes of discussion, the client device 104 can be used by an administrator, a key user, or an analyst, etc., who has appropriate permissions. Additionally, the ERP application 108 and the ERP application 118 can be a same application that is presented differently (e.g., in a browser) to different users, on different client devices, based on appropriate roles permissions of a respective user.

The analyst client device 104 and the end-user client device 105 includes processor(s) 160 or processor(s) 162, respectively. Each processor included in the processor(s) 160 or processor(s) 162 may be a central processing unit (CPU), an application specific integrated circuit (ASIC), a field-programmable gate array (FPGA), or another suitable component. Generally, each processor included in the processor(s) 160 or processor(s) 162 executes instructions and manipulates data to perform the operations of the analyst client device 104 or the end-user client device 105, respectively. Specifically, each processor included in the processor(s) 160 or processor(s) 162 executes the functionality required to send requests to the server device or system (e.g., the server 102 or the cloud platform 107) and to receive and process responses from the server device or system.

Each of the analyst client device 104 and the end-user client device 105 are generally intended to encompass any client computing device such as a laptop/notebook computer, wireless data port, smart phone, personal data assistant (PDA), tablet computing device, one or more processors within these devices, or any other suitable processing device. For example, the analyst client device 104 and/or the end-user client device 105 may comprise a computer that includes an input device, such as a keypad, touch screen, or other device that can accept user information, and an output device that conveys information associated with the operation of the server 102, or the respective client device itself, including digital data, visual information, or a GUI (Graphical User Interface) 164 or GUI 166, respectively.

The GUI 164 and the GUI 166 can each interface with at least a portion of the system 100 for any suitable purpose, including generating a visual representation of the ERP application 118 or the ERP application 108, respectively. In particular, the GUI 164 and the GUI 166 may each be used to view and navigate various Web pages, or other user interfaces. Generally, the GUI 164 and the GUI 166 each provide the user with an efficient and user-friendly presentation of business data provided by or communicated within the system. The GUI 164 and the GUI 166 may each comprise a plurality of customizable frames or views having interactive fields, pull-down lists, and buttons operated by the user. The GUI 164 and the GUI 166 each contemplate any suitable graphical user interface, such as a combination of a generic web browser, intelligent engine, and command line interface (CLI) that processes information and efficiently presents the results to the user visually.

Memory 168 or memory 170 included in the analyst client device 104 or the end-user client device 105 may each include any memory or database module and may take the form of volatile or non-volatile memory including, without limitation, magnetic media, optical media, random access memory (RAM), read-only memory (ROM), removable media, or any other suitable local or remote memory component. The memory 168 and the memory 170 may each store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the analyst client device 104 or the end-user client device 105.

There may be any number of customer client devices 104 and end-user client device 105 associated with, or external to, the system 100. For example, while the illustrated system 100 includes one analyst client device 104 and one end-user client device 105, alternative implementations of the system 100 may include multiple customer client devices 104 and/or multiple dashboard client devices 105 communicably coupled to the server 102 and/or the network 107, or any other number suitable to the purposes of the system 100. Additionally, there may also be one or more additional customer client devices 104 and/or dashboard client devices 105 external to the illustrated portion of system 100 that are capable of interacting with the system 100 via the network 107. Further, the term “client”, “client device” and “user” may be used interchangeably as appropriate without departing from the scope of this disclosure. Moreover, while the analyst client device 104 or the end-user client device 105 may be described in terms of being used by a single user, this disclosure contemplates that many users may use one computer, or that one user may use multiple computers.

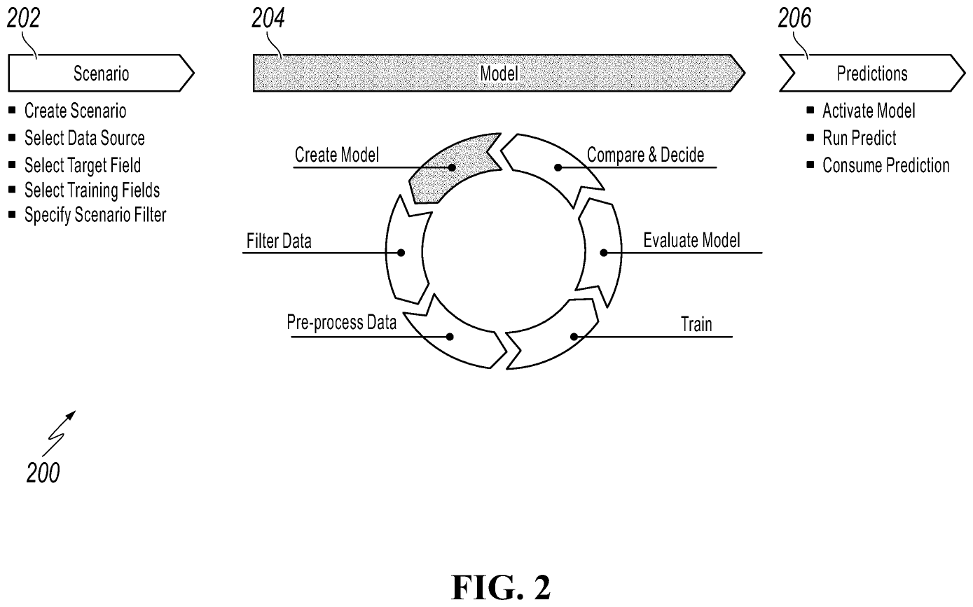

FIG. 2 is a diagram 200 that illustrates a process flow for a machine learning work center. As mentioned, the systems and processes described herein can be used for ML or for AI more generally. The machine learning work center can guide a user through a sequence of pipeline steps for machine learning. The pipeline can include steps related to scenarios 202, models 204, and predictions 206.

For scenarios 202, the user can create scenarios, select a data source for a scenario, select a target field, select training fields, and specify a scenario filter. For models 204, the user can create models, apply data filtering, configure data pre-processing, train models, and evaluate models based on different metrics. The user can, during model evaluation, compare models and decide on a model to use for predictions 206. To generate predictions 206 the user can activate a selected model and run a prediction using the activated model to get prediction results. The prediction results can be consumed in different user interfaces, such as an interface for an object that includes the target field.

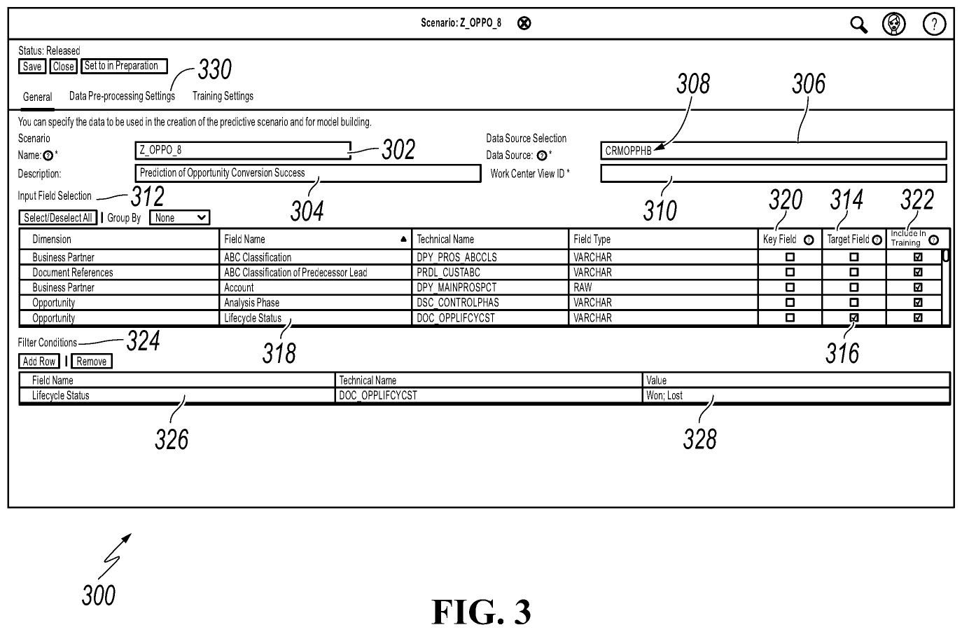

FIG. 3 illustrates a user interface 300 for editing or creating a scenario. The scenario can be a ML scenario or an AI scenario. As such, the user interface 300 and other user interfaces described below can be applied to AI as well as ML use cases. A user can use the user interface 300 to specify what data will be used for a scenario and for model building. A scenario name can be entered into a name field 302. The scenario name can uniquely identify a scenario. A description, which can be free text that describes a purpose of the scenario, can be entered into a description field 304. For example, the illustrated scenario has a purpose of predicting an opportunity conversion success.

A data source for the scenario can be specified using a data source field 306. The data source for a scenario is an analytical data source that includes data that can be used for model training. The user can select a data source, for example, from any data source in the ERP system. Although a technical name 308 of CRMOPPHB is shown in this example, upon selection of the data source field 306, the user can be shown a list of data sources organized by a logical data source name and/or data source description, from which the user can select an appropriate data source. For example, a sales person user can select a logical data source name of Opportunity Header which is familiar to the sales person user.

A work center view field 310 can be used to select a work center for the scenario. For example, if the model creator is creating an opportunity success scenario and adds “Opportunity Table View” Work Center ID then only the model creators with this role assigned will be able to see this model and get visibility on the needed opportunity data to train the related models for this scenario. This ensures role and data segregation in the AI/ML Work Center following the same principle as in the base ERP system.

An input field selection area 312 includes an automatically populated list of data source fields from the selected data source. The user can select one or more check boxes in a target field column 314 to specify target field(s) for the scenario. For instance, the user has selected a check box 316 for a lifecycle status data source field 318 to specify the lifecycle status field 318 as a target field. A target field is a field that includes “classes” or “labels” (e.g., distinct values that a machine learning model can learn to predict). For example, the lifecycle status field 318 can include values that indicate if an opportunity was won or lost.

For a field of the data source that is a key field that uniquely identifies data source rows, a key field column 320 can include a selected check box indicating to the user which field of the data source is the key field. An include-in-training column 322 includes selectable check boxes that can be selected to indicate that corresponding data source fields include information that may be helpful for the machine learning model. Fields are selected for ML training based on whether a corresponding include-in-training checkbox is selected. The key field and the target field are automatically included for training when selected. In some implementations, the system automatically determines default selections for other fields as initial recommendations for the user. A user who has knowledge of which fields to include in training can modify the default selections.

A filter conditions area 324 can be used to restrict which rows of the data source are relevant for training. For instance, for the example of predicting opportunities, a filter condition 326 can be added that restricts training to only closed documents in which a won/lost result 328 is known. The user can select a tab 330 to continue with creation of the scenario.

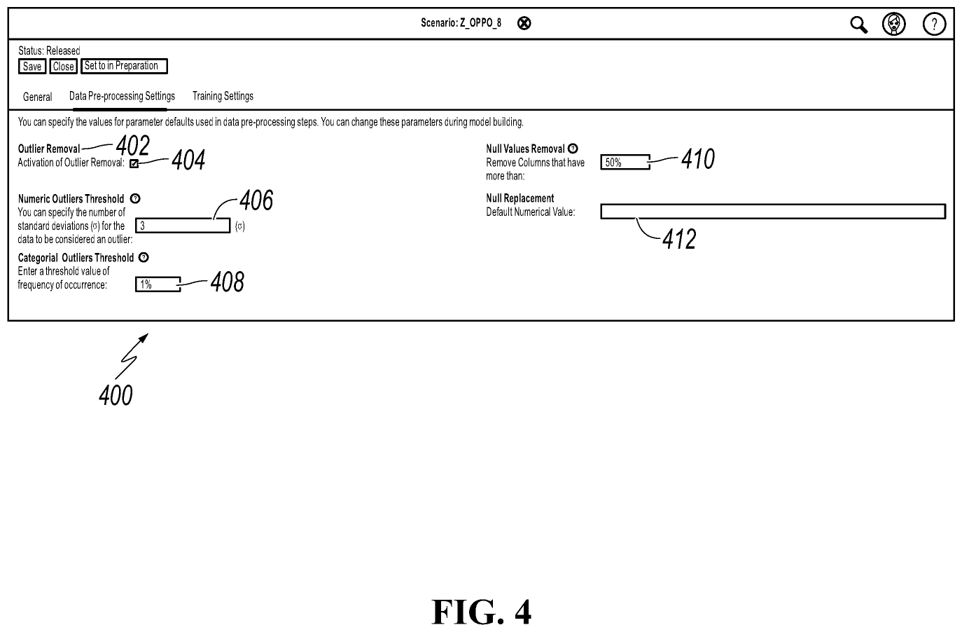

FIG. 4 illustrates a user interface 400 for data pre-processing settings for scenarios. The user interface 400 can display, for a new scenario, best practice data pre-processing settings as default data pre-processing settings for the scenario. The user can modify the initial default settings for the scenario. Data pre-processing can be performed to handle data quality issues, such as outliers and nulls. When a model is created for the scenario, the model can inherit the data pre-processing settings of the scenario. A user can modify, for a given model, the data pre-processing settings inherited from the scenario, if desired.

Outliers are field values which statistically differ from other values in the same field or are very rarely occurring values. An outlier can indicate that an error happened during data recording or processing. For example, a person having a height of 300 centimeters is an outlier value. Outlier settings can be configured in an outlier removal area 402.

Activation of outlier removal can be configured by selection of an outlier activation checkbox 404. The activation of outlier removal option controls whether outlier removal is performed during model building. By default, outlier removal is performed.

A numeric outliers threshold 406 can be specified as a number of standard deviations for data to be considered as an outlier. For example, when removing outliers from numerical fields, first a mean and standard deviation (e.g., sigma) of field values is computed. Then values that falls outside of an interval of mean−k*σ, mean+k*σ are considered as outliers, where k is a sigma multiplier. Rows containing these outliers are deleted during outlier removal. A default value for the sigma multiplier (k) is 3.

A categorical outliers threshold 408 can be specified as a threshold value for frequency of occurrence for categorical fields. For example, when removing outliers from categorical fields, first a list of distinct field values is created, and for every categorical value a frequency of its occurrence is calculated. The list of distinct values is then ordered according to frequency. Values which occur less frequently than the specified categorical outliers threshold 408 are considered as outliers. Rows including these outliers are deleted. A default value for the categorical outliers threshold is 5%.

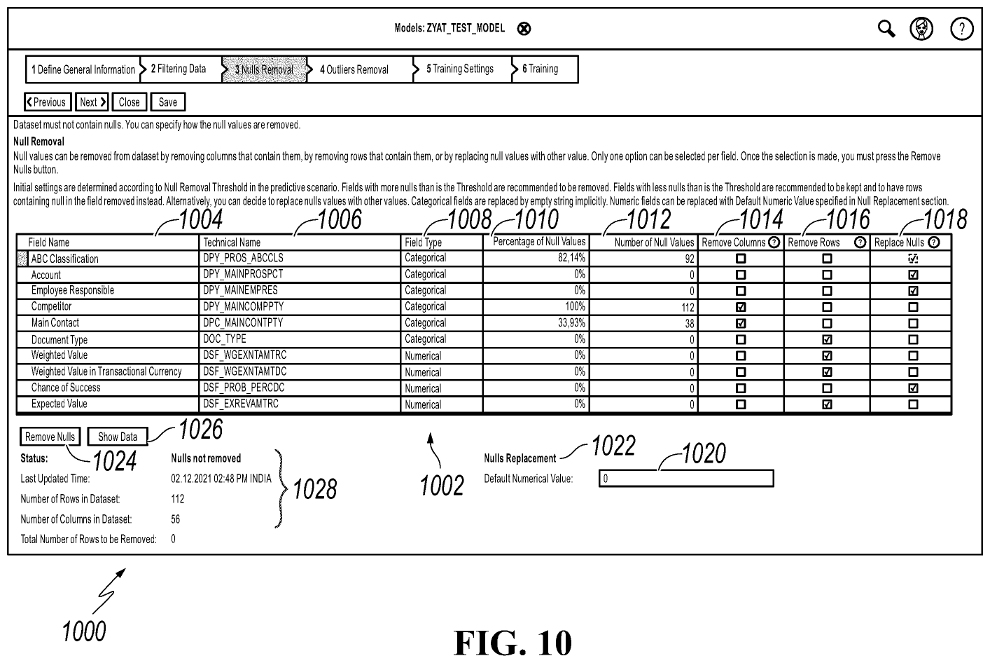

Nulls are special database data values whose content is not defined. Model training processes do not allow null values. Null values can be removed by either deleting rows that include null values or by deleting columns that include values. A best strategy may depend on a specific distribution of nulls in a dataset. During model definition (e.g., as described below with respect to FIG. 10), null removal can be configured on a per-field basis.

Default null removal handling for models of a scenario can be configured using a null values removal threshold 410. For example, a default null removal strategy can be to delete columns if they contain more than the null values removal threshold 410 of null values, and to delete respective rows if they contain less than the null values removal threshold 410. A default value for the null values removal threshold can be, for instance, 50%.

Default null removal handling for models of a scenario can also be configured using a nulls replacement value 412. For example, nulls removal can include replacing null values in numerical fields with the nulls replacement value 412. Replacing just null values can prevent full rows or columns from being deleted, which can be important for model training especially for smaller data sets. However, care should be taken to ensure that new values chosen to represent undefined data (nulls) do not interfere with other values that have defined semantics. In general, a best practice recommendation can be to not perform null replacement for numerical fields, so as to not bias models towards the replacement values. However, null removal handling can be performed so that for categorical fields, null values are replaced by an empty string. Replacement of nulls in categorical fields can be considered as a generally safe replacement method.

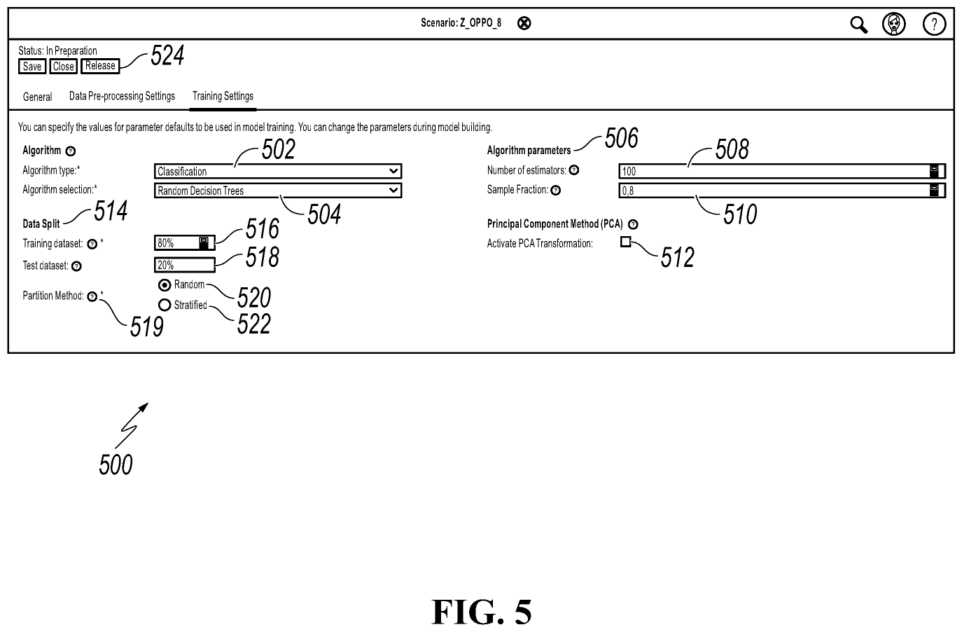

FIG. 5 illustrates a user interface 500 for training settings for scenarios. The user interface 500 can be used to specify default parameters used in model training. An algorithm type for the scenario can be specified using an algorithm type selection control 502. Different types of algorithms can be selected. In general, machine learning algorithms differ in the type of problems they solve. Algorithm types can include classification, clustering, regression, association, time series, pre-processing, statistics, social network analysis, recommender system, data intelligence, and other types of algorithms.

When a classification type is selected in the algorithm type selection control 502, a specific algorithm used to solve classification problems can be selected using an algorithm selection control 504. Supported classification algorithms include Hybrid Gradient Boosting Tree, Random Decision Trees, and Support Vector Machine. For instance, a Random Decision Trees algorithm is currently selected. Each algorithm can have a separate set of parameters that can be specified in an algorithm parameters section 506. For instance, for the Random Decision Trees algorithm, a number of estimators parameter 508 and a sample fraction parameter 510 can be specified. Best practice default parameter values can be presented but the user can modify the parameter values if desired. The number of estimators parameter 508 specifies a number of trees to grow for the Random Decision Trees algorithm. The sample fraction parameter 510 specifies a fraction of data used for training.

A checkbox 512 can be selected to activate a Principal Component Analysis (PCA). PCA can transform a vector space of the data source into a new set of uncorrelated variables (fields). A PCA transformed data source makes model training easier and the produced model is often of higher quality as compared to non-transformed data. PCA can be used for numerical fields, which will be replaced with PCA fields. Since PCA works with numerical fields, if the data source of the scenario has no numerical fields, the checkbox 512 for PCA selection is automatically deselected.

A data split area 514 can be used to specify a split between training data and test data. A training dataset control 516 can be used to specify a percentage of dataset data used by the selected algorithm to train a model. A test dataset label 518 indicates a remaining portion of data source data to be used for validation of a trained model. Model evaluation metrics can be calculated on the test dataset.

A partition method section 519 enables a user to defines a method for how data source data will be split into the training dataset and the test dataset. For example, a random setting 520 can be selected to specify that data samples are to be randomly selected from the full data source for inclusion in either the training dataset or the test dataset. As another example, a stratified setting 522 can be selected to specify that a data selection method is used that ensures that a statistical proportions of classes (e.g., target field values) in the full data source are preserved in the training dataset and the test dataset.

After the user has configured the training settings in the user interface 500, the user can release the scenario by selecting a release button 524. Models created for the scenario can inherit the default training settings specified in the user interface 500. However, for individual models, the training settings parameters, other than algorithm type and selected algorithm, can be changed during model building (e.g., as described in more detail below).

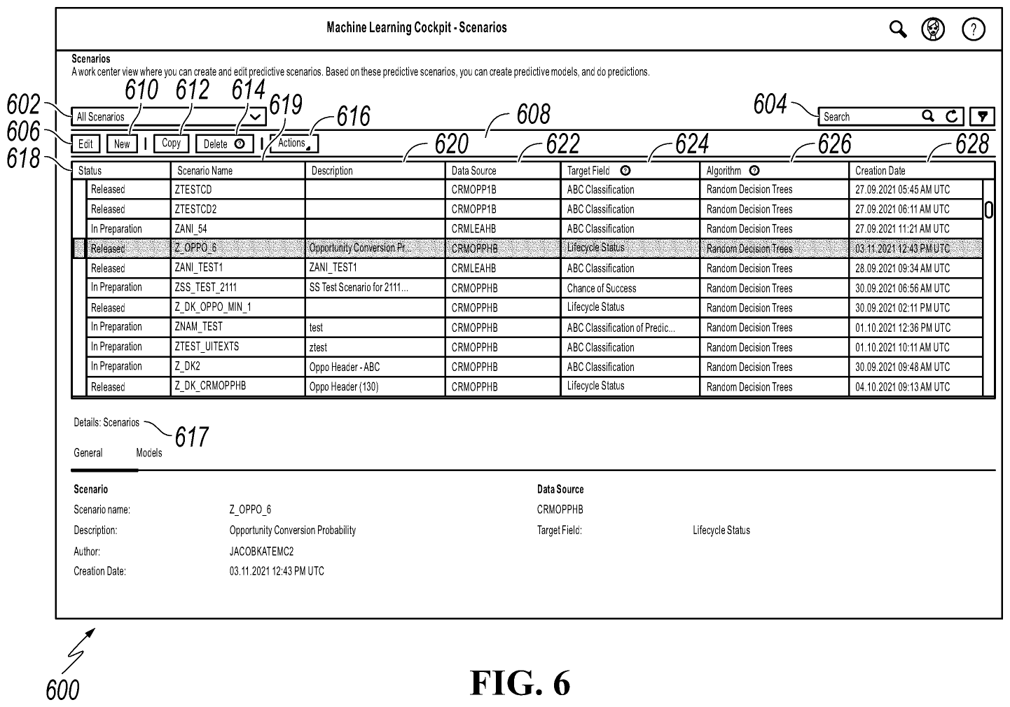

FIG. 6 illustrates a scenario list user interface 600. The scenario list user interface 600 displays a list of existing predictive scenarios with scenario details for each scenario. A filter control 602 can be used to filter selected scenarios or to display all scenarios. Scenarios can be filtered to display scenarios delivered by a service provider or customer scenarios built by a customer, for example. The service provider can provide scenarios to certain types of customers, for example.

A search control 604 can be used to search for a scenario by scenario name. The user can select an edit control 606 to edit a scenario selected in a scenario list 608. A new scenario can be created in response to user selection of a new button 610. For instance, the user interface 300 can be displayed for the new scenario in response to selection of the new button 610. A selected scenario can be copied in response to selection of a copy button 612. All data from the selected scenario can be copied to a new scenario, except for the scenario name. A selected scenario can be deleted in response to selection of a delete button 614. Various other status related actions can be selected and performed on a selected scenario in response to selection of an action control 616 such as “Set to in Preparation” and “Set to Released” (e.g., only released scenarios allow for model training). When a scenario is selected in the scenario list 608, details for the scenario can be displayed in a details area 617.

The scenario list 608 can display, for each scenario, a scenario status 618, a scenario name 619, a scenario description 620, a data source 622, a target field 624, an algorithm 626, and a creation date 628. Regarding scenario statuses, when a scenario is created and saved, the scenario has an initial status of “In Preparation”. Scenarios with the “In Preparation” status can still be edited or deleted but cannot be used to create models until after being released. A scenario with status of “Released” is a scenario that is complete and ready for model creation. Released scenarios with associated models can't be edited or deleted. A scenario status can be changed from “Released” back to “In Preparation” if there are no models created for the scenario.

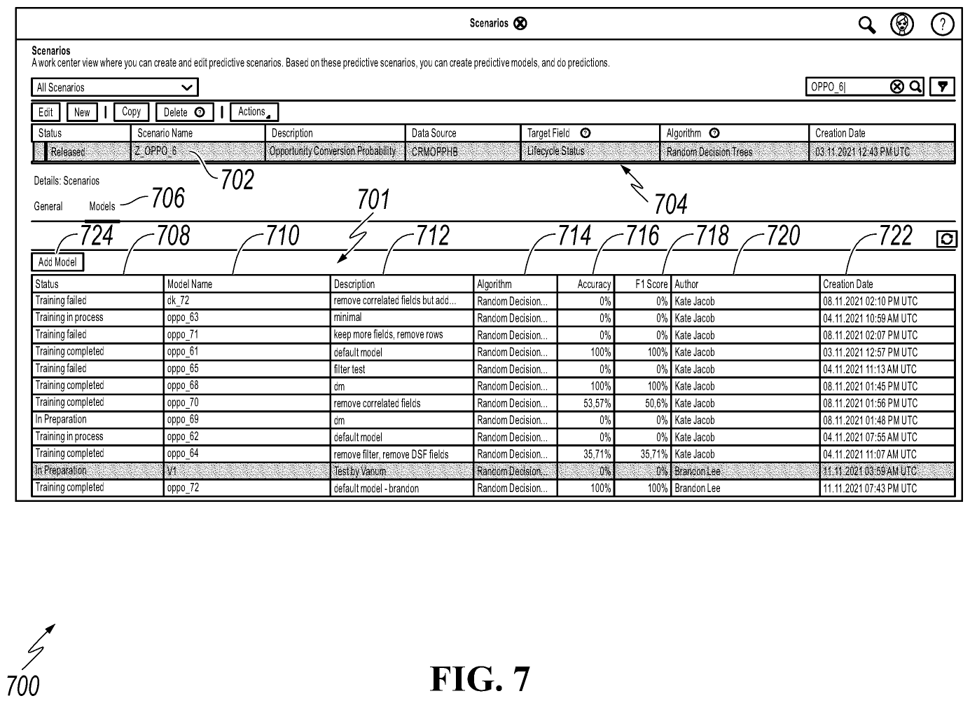

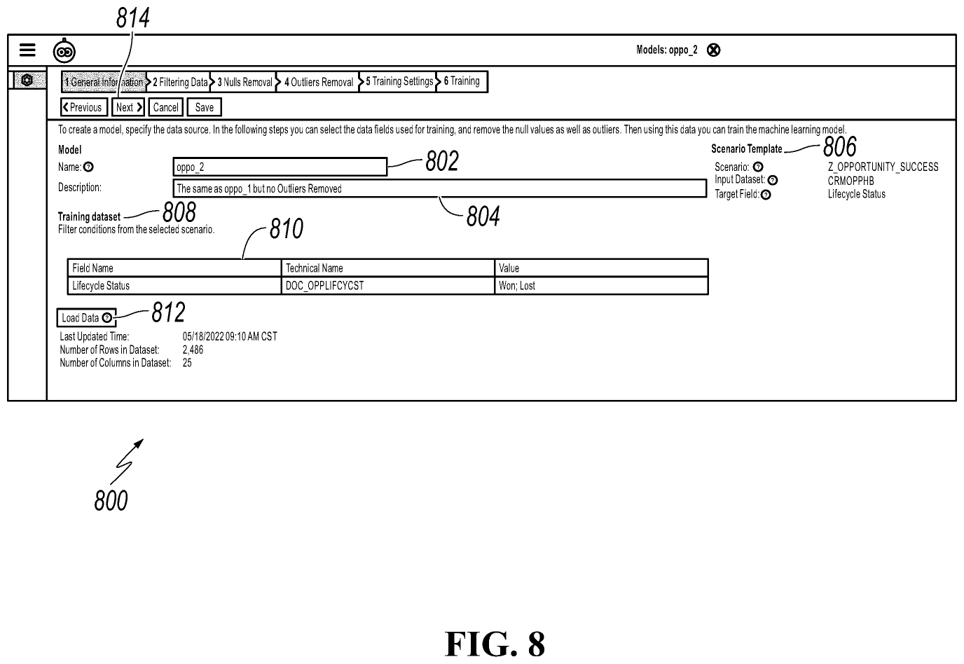

FIG. 7 illustrates a scenario list user interface 700. The scenario list user interface 700 displays, in a model list 701, information for models of a scenario 702 that is selected in a scenario list 704 in response to selection of a models tab 706. The model list 701 provides an overview of all models created for the selected scenario 702. The model list 701 includes, for each model, a model status 708, a model name 710, a model description 712, an algorithm 714, a model accuracy 716, a model F1 score 718, a model author (e.g., creator) 720, and a model creation date 722. Model accuracy and F1 scores are described in more detail below. The user can use the model list 701 for comparison of models for a scenario, for deciding which model of the scenario is best suited for predictions. The user can select an add model button 724 to add a new model for the selected scenario 702. Model creation is described in more detail below with respect to FIGS. 8-13.

FIG. 8 illustrates a user interface 800 for creating or editing a model. The user interface 800 includes some editable fields for the model and also a number of read-only fields that display information from the scenario for which the model is created. For example, a model name can be entered into a name field 802. The model name can uniquely identify a model within the model's scenario. A description, which can be free text that describes a purpose of the model, can be entered into a description field 804.

A scenario information area 806 includes read-only information about the scenario for the model, such as a scenario name, scenario input dataset, and scenario target field. A training dataset information area 808 includes information for filter conditions 810 from the scenario of the model and other training data set information 812. Further information for the model can be specified in other model building screens. A next model user interface can be displayed in response to selection of a next button 814.

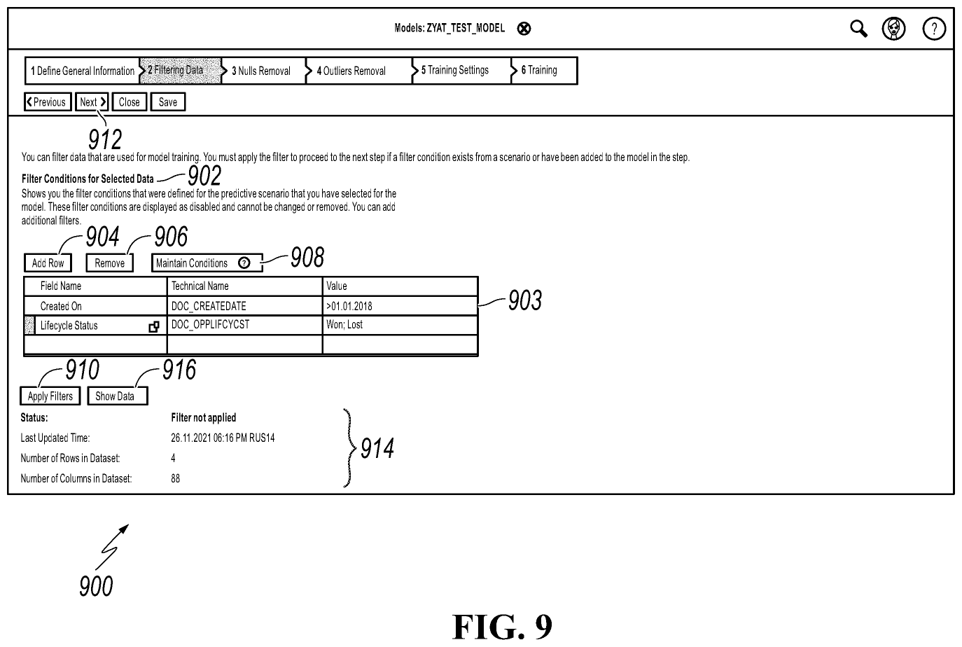

FIG. 9 illustrates a user interface 900 for data filtering settings for a model. Filters for a model restrict what part of the scenario data source (e.g., which rows) are relevant for training. The model initially inherits filter settings from the scenario, but the user can make some filtering customizations for the model being created or edited. A filter conditions section 902 includes, in a filter condition list 903, filters that were defined for the scenario. Filter conditions defined in the scenario cannot be removed for the model and are shown as read-only in the filter condition list 903. However, additional filters can be added by selecting an add row button 904. A filter that has been added for the model can later be removed by selecting a remove button 906. Filter conditions for an added model can be maintained by selecting a maintain conditions button 908.

If the filter list 903 includes any filter conditions, the user can select an apply filters button 910 to proceed to a next step in model creation. For instance, a next button 912 becomes enabled after the apply filters button 910 is selected. A status area 914 displays information regarding status of filter application. After filters have been applied, a show data button 916 becomes enabled. The user can select the show data button 916 to view an analytical report that shows dataset data that is filtered by the applied filter conditions. The user can visualize the filtered data and make some changes to filtering conditions, such as removing certain columns (e.g., columns that substantially have the same data in each row).

FIG. 10 illustrates a user interface 1000 for nulls removal settings for a model. A dataset used for ML training can have null values removed before the model is trained. The user interface 1000 includes settings for defining how null values are removed for each field of the dataset. Afield list 1002 displays information and null removal settings for each field of the dataset. For example, the field list 1002 includes, for each field, a field name 1004, a technical name 1006 of the field, a field type 1008, a percentage of null values 1010 for the field, a number of null values 1012 for the field, a remove columns setting 1014, a remove rows setting 1016, and a replace nulls setting 1018.

Null values can be removed from the dataset by removing columns that include them (e.g., by selecting the remove column setting 1014 for a field), by removing rows that include them (e.g., by selecting the remove rows setting 1016 for a field), or by replacing null values with another value (e.g., by selecting the replace nulls setting 1018 for a field). Only one option (e.g., the remove column setting 1014, the remove rows setting 1016, or the remove nulls setting 1018) should be selected per field.

Initial settings are defined based on the scenario data pre-processing settings (e.g., as described above with respect to FIG. 4). For example, if the null removal threshold defined in the scenario is 50%, then fields with more than 50% have the remove columns setting 1014 selected and fields with less than 50% nulls have the remove rows setting 1016 selected. Accordingly, recommended default settings can be presented to the user, but the user can change the default settings based on having specific domain or dataset knowledge or experience, for example.

The user can choose to select the replace nulls setting 1018 for a field after carefully considering whether null replacement is appropriate for the field (e.g., as described above). Categorical fields are implicitly replaced by an empty string value. Numeric fields can be replaced with a default numeric value 1020 specified in a null replacement section 1022. The default numeric value 1020 for the model can be initially set to a corresponding value from the scenario, but the user can modify the default numeric value 1020 for the given model.

Once null-removing settings have been made (or confirmed) for each field, the user can select a remove nulls button 1024 to cause nulls to removed according to the settings displayed in the user interface 1000. After nulls are removed, the user can select a show data button 1026 to view dataset data after null removal. A status area 1028 displays null removal status information (e.g., whether nulls have been removed) and information about the dataset (e.g., either before or after nulls removal, as appropriate).

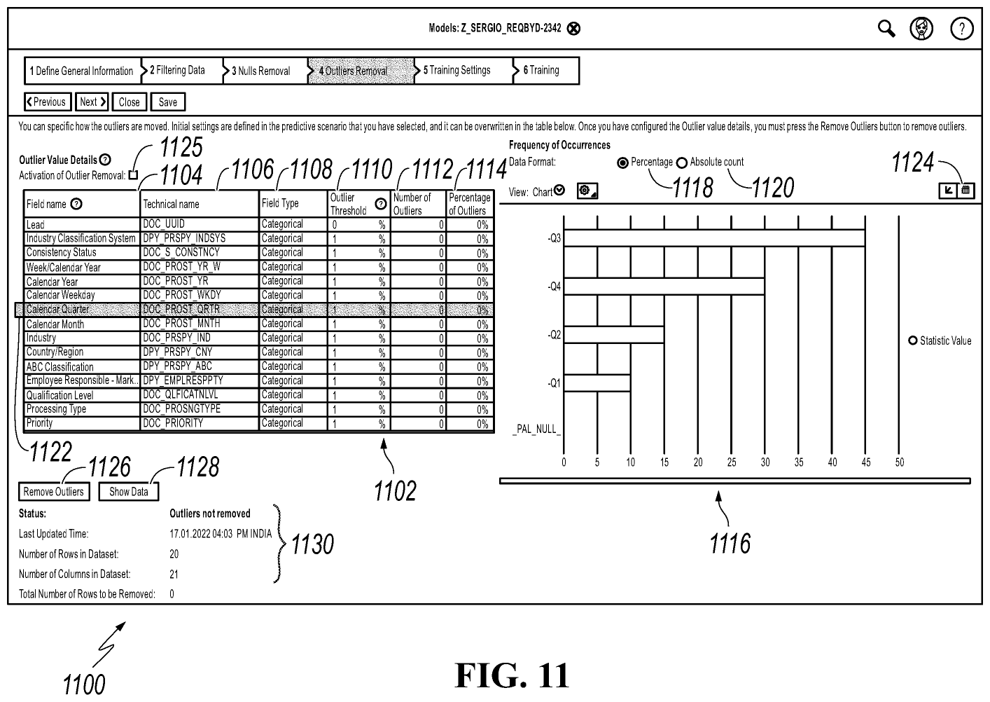

FIG. 11 illustrates a user interface 1100 for outlier removal settings for a model. Using the user interface 1100, the user can specify how outliers are removed. Initial settings are defined in the predictive scenario but can be overwritten in a field list 1102. Removal of outliers from a dataset can improve a trained ML model as compared to the ML model being trained with outliers still in the dataset.

The field list 1102 displays information and outlier removal settings for each field of the dataset. For example, the field list 1102 includes, for each field, a field name 1104, a technical name 1106 of the field, a field type 1108, an outlier threshold 1110, an outlier count 1112, and an outlier percentage 1114. When a field is selected in the field list 1102, a chart 1116 can be displayed that provides a visual representation of field data distribution. The chart 1116 can show field data distribution by percentage if a percentage setting 1118 is selected or by absolute count if an absolute count setting 1120 is selected.

As an example, a Calendar Quarter field 1122 is selected in the field list 1102, the percentage setting 1118 is selected, and the chart 1116 displays field values (e.g., Q1, Q2, Q3, Q4) for the Calendar Quarter field 112 and graphical representations of percentage frequency of occurrence in the dataset for each field value. If a numerical field is selected in the field list 1102, the chart 1116 can display ranges of field values that are broken into equally spaced bins. For every bin, the chart 1116 can include a graphical representation of a number of values that fall into that bin. The user can select a tabular button 1124 to view a tabular version of information that is currently displayed in the chart 1116.

The user can accept or modify outlier threshold 1110 values in the field list 1102 for each field. Settings in the field list 1102 can be accepted by selecting an outlier activation option 1125. As another example, a user can decide to keep all outliers for a dataset by deselecting the outlier activation option 1125. Once the user has configured (or confirmed) outlier threshold 1110 values in the field list, the user can select a remove outliers button 1126 to remove the outliers.

As described above with respect to FIG. 4, for numeric fields, the outlier threshold 1110 represents a number of standard deviations for data to be considered as an outlier. For example, when removing outliers from numerical fields, first a mean and standard deviation (e.g., sigma) of field values is computed. Then values that falls outside of an interval of mean−k*σ, mean+k*σ are considered as outliers, where k is a sigma multiplier. Rows containing these outliers are deleted during outlier removal. A default value for the sigma multiplier (k) is 3. For categorical fields, the outlier threshold 1110 represents a threshold value for frequency of occurrence. For example, when removing outliers from categorical fields, first a list of distinct field values is created, and for every categorical value a frequency of its occurrence is calculated. The list of distinct values is then ordered according to frequency. Values which occur less frequently than the specified threshold value are considered as outliers. Rows including these outliers are deleted.

After outliers are removed, the user can select a show data button 1128 to view dataset data after outlier removal. A status area 1130 displays outlier removal status information (e.g., whether outliers have been removed) and information about the dataset (e.g., either before or after outlier removal, as appropriate).

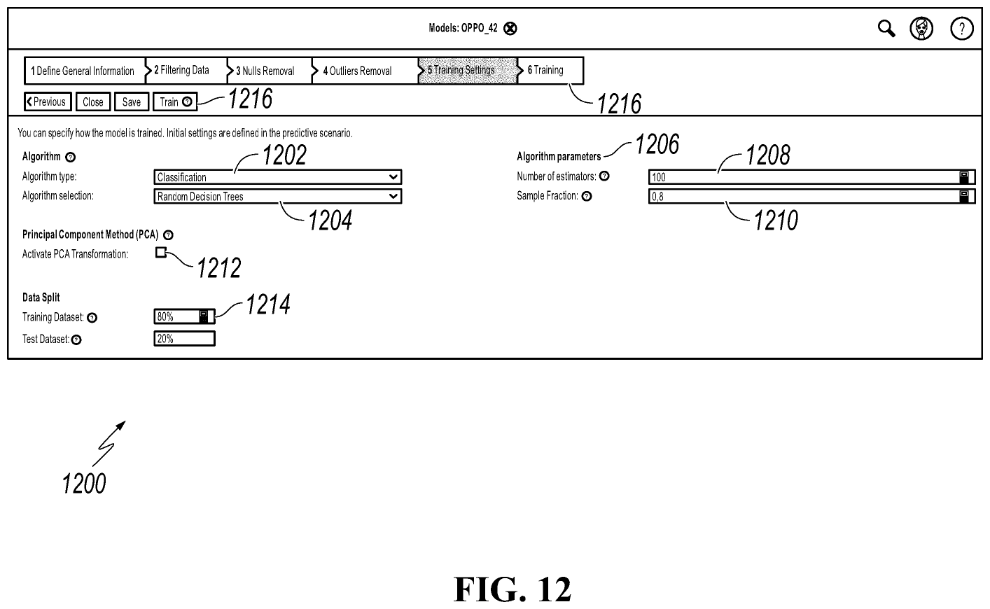

FIG. 12 illustrates a user interface 1200 for training settings for a model. The model can inherit training settings from the scenario of the model. However, a user can customize training settings, other than an algorithm type 1202 and an algorithm 1204, which are displayed as read only information.

The user can change algorithm parameters 1206. For instance, for the selected Random Decision Trees algorithm, the user can change a number of estimators parameter 1208 and/or a sample fraction parameter 1210. The user can select a checkbox 1212 to activate PCA transformation. The user can modify a percentage value in a training dataset portion control 1214, which can determine a split between the training dataset and a test dataset.

Once the user is satisfied with the training settings, the user can initiate training of the model by selecting a train button 1216. In response to selection of the train button 1216, the training parameters displayed in the user interface 1200 and other model information can be provided to the predictive analytics library. The predictive analytics library can train the model, based on the training parameters and the other model information. Training results can be displayed in response to selection of a training tab 1216, as described in more detail below.

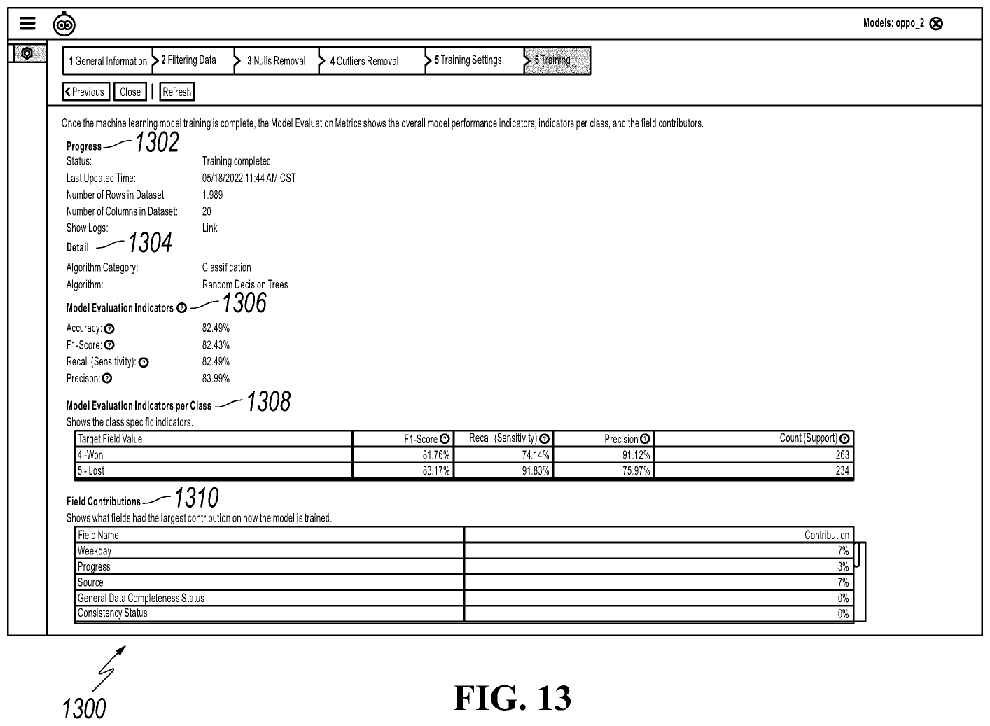

FIG. 13 illustrates a user interface 1300 for training status for a model. The user interface 1300 displays training status in a progress area 1302. The training status can indicate whether training has completed. A detail area 1304 displays information regarding an algorithm and algorithm category of the model being trained.

When training is complete for the model, model evaluation metrics are displayed in a model evaluation indicators area 1306, a model evaluation indicates per class area 1308, and a field contributions area 1310. The field contributions area 1310 displays information regarding what fields of the scenario dataset had the largest contributions for how the model was trained. The model evaluation metrics include various indicators that estimate the ability of the trained model to make a correct prediction.

For example, the model evaluation indicators area 1306 displays metrics for the model as a whole and the model evaluation indicators per class area 1308 displays class-specific metrics. Each of the model evaluation indicators area 1306 and the model evaluation indicators per class area 1308 can display information for accuracy, F1 scores, recall (sensitivity), and precision. Accuracy metrics indicate a proportion of training dataset samples that were correctly predicted by the model. For example, for the opportunity prediction example, what proportion of samples were predicted correctly as either “Won” or “Lost”? Recall (sensitivity) metrics indicate how well the model predicted samples of a specific class. For example, what proportion of “Won” samples were predicted as “Won”? Precision metrics indicate a proportion of predictions of a specific class that were predicted correctly. For example, what proportion of “Won” predictions are indeed “Won”? F1 score metrics combine the precision and recall of a classifier into a single metric by taking their harmonic mean.

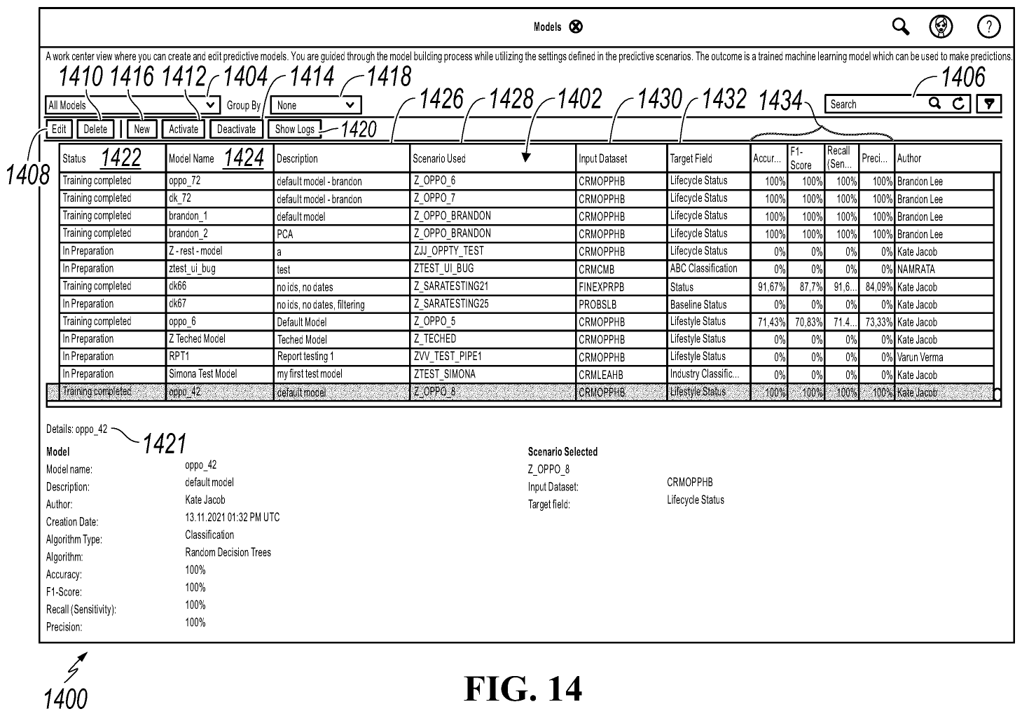

FIG. 14 illustrates a model list user interface 1400. The model list user interface 1400 provides a consolidated view of all models, as well as additional model management functions. A model list 1402 can be filtered using a model filter control 1404. For example, the user can display all models or only active models. A user can search for a model using a search control 1406. A selected model can be edited, deleted, activated, or deactivated in response to user selection of an edit button 1408, a delete button 1410, an activate button 1412, or a deactivate button 1414, respectively. Creation of a new model can be initiated in response to user selection of a new button 1416. Models can be grouped (e.g., by scenarios) in response to selection of a group by control 1418. Application logs for models can be displayed (e.g., for troubleshooting purposes) in response to user selection of a show logs button 1420. A details section 1421 displays model details for a model that is selected in the model list 1402.

The model list 1402 includes model detail information for displayed models. For example, the model list 1402 includes, for each displayed model, a model status 1422, a model name 1424, a model description 1426, a scenario of the model 1428, the input dataset for the model 1430, the target field 1432, and accuracy information 1434 (e.g., accuracy, F1 score, recall (sensitivity), and precision).

Regarding model status 1422, when a model is created and saved, an initial status is “In Preparation”. When model training has started for a model, the model status 1422 is “Training in Process”. When model training is done for the model, the status of the model is “Training Completed” or “Training Failed”. A status of “Training Completed” means that training was successful and model evaluation metrics are available. A status of “Training Failed” means that some error occurred during model training and an application log can be checked to find the cause. A successfully trained model can have a status of “Active”, which means that the model can be used for predictions. In some implementations, a scenario that has multiple trained models can have only one model set to an “Active” status. An active model can be deactivated to change the status of the model from “Active” to “Training completed”.

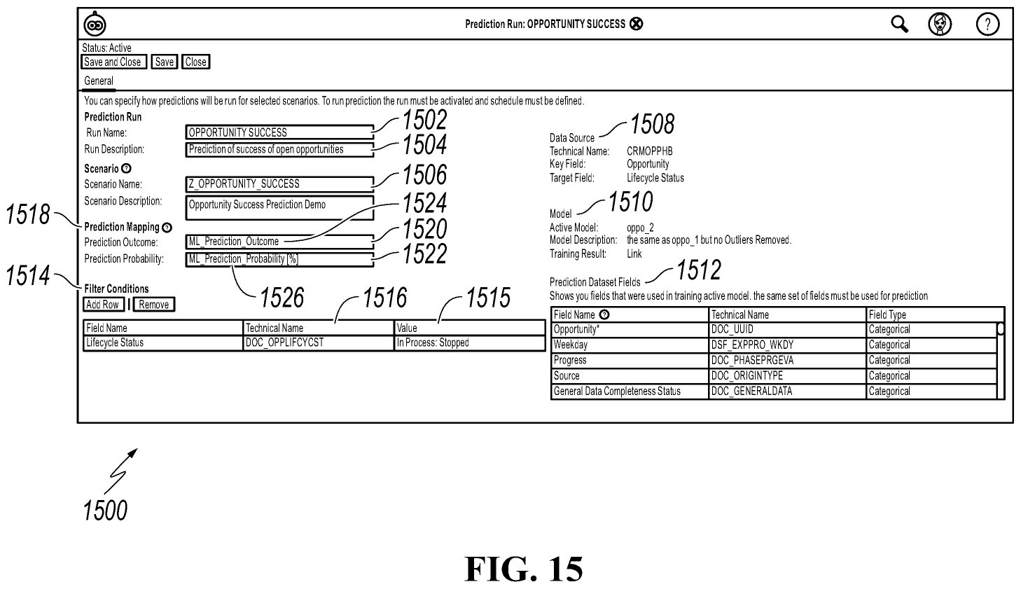

FIG. 15 illustrates a user interface 1500 for editing or creating a prediction run. A trained ML model can be used for predictions of target field values of a prediction-relevant part of a dataset, as defined in a scenario configuration. The trained model has learned, through training, behavior about the dataset. For instance, for the opportunity dataset, a trained model may have learned in which conditions an opportunity may be lost or won. For a new opportunity, the trained model can be used to predict whether the opportunity will be lost. Such a prediction can be made using a prediction run.

A prediction run name 1502 can uniquely identify a prediction run. A prediction run description 1504 can include free text that describes the purpose of the prediction run. A user can specify a scenario 1506 that defines data that can be used for making predictions using the prediction run. A data source area 1508 displays read-only information about the scenario data source.

Predictions can be generated using the prediction run by using an active model of the prediction run. A model area 1510 displays read-only information about the scenario active model. A prediction dataset fields area 1512 displays information about fields that were used for training of the active model. These fields are used to make predictions for the prediction run.

Filter conditions for the prediction run can be defined in a filter conditions area 1514. A filter condition for a prediction run can restrict what part of the scenario data source (e.g., which rows) are relevant for the prediction run. For instance, for an opportunity, the active model may have been trained on closed opportunity documents in which a won/lost result is known, but for the prediction run, as shown by conditions 1515 for a filter 1516, predictions can be made for opportunity objects that are in process or stopped (e.g., where a won/lost result is not yet known).

A prediction mapping area 1518 can be used to specify where prediction results for the prediction run are stored. For example, the user can specify where to store a prediction outcome 1520 and a prediction probability 1522. Prediction results can, for example, be stored in extension fields of an object for which the prediction is made or in other types of database fields. For instance, the user has specified that the prediction outcome 1520 and the prediction probability 1522 are to be stored in a ML Prediction Outcome extension field 1524 and a ML Prediction Probability extension field 1526, respectively. The ML Prediction Outcome extension field 1524 and the ML Prediction Probability extension field 1526 are fields of a backend database table, for example. As described below, the system can enable the user to consume these values in one or more user interfaces.

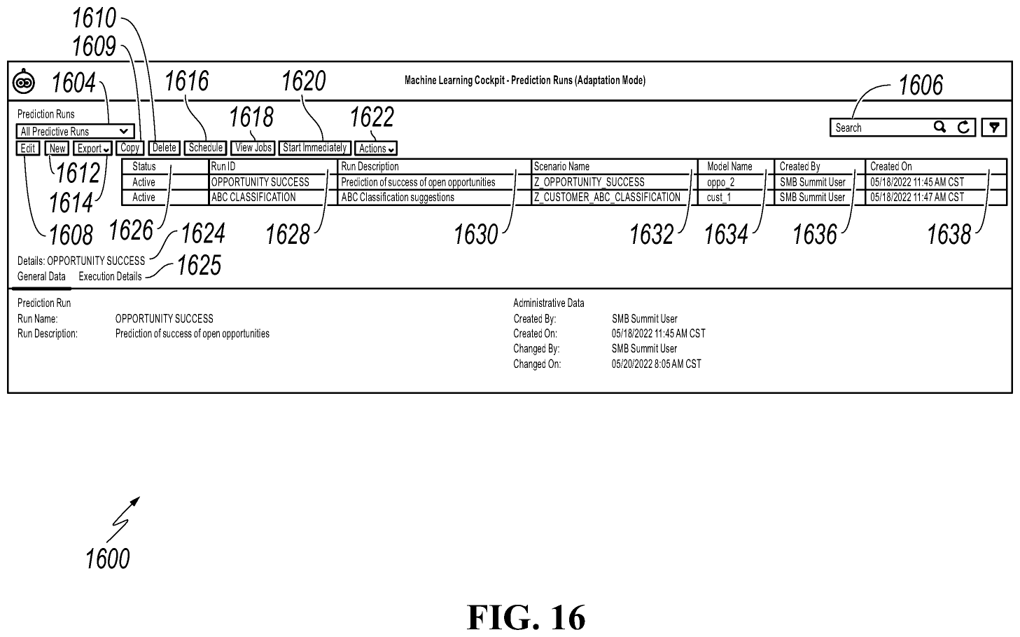

FIG. 16 illustrates a prediction run list user interface 1600. The prediction run list user interface 1600 provides a consolidated view of prediction runs, as well as additional prediction run management functions. A prediction run list 1602 can be filtered using a filter control 1604. For example, the user can filter prediction runs by prediction run status values. A user can search for a prediction run using a search control 1606. A selected prediction run can be edited, copied, or deleted in response to user selection of an edit button 1608, a copy button 1609, or a delete button 1610, respectively. Creation of a new model can be initiated in response to user selection of a new button 1612. The user can initiate an export of information for the prediction runs in the prediction run list 1602 (e.g., to a spreadsheet file) by selecting an export button 1614.

A selected prediction run can be scheduled in response to user selection of a schedule button 1616. Prediction runs can be scheduled to run periodically (e.g., every day, twice per day, etc.). As another example, a prediction run can be scheduled to run in response to a new record (e.g., a new opportunity) being added to the data source of the scenario. Prediction runs can be scheduled as background jobs. Information for prediction run jobs can be displayed in response to a view jobs button 1618. In addition or alternatively to scheduling prediction runs, the user can request a real-time starting of a prediction run by selecting a start immediately button 1620.

Various other status related actions can be selected and performed on a selected scenario in response to selection of an action control 1622 (e.g., “Set to Active” or “Set to Obsolete”). A details section displays 1624 details for a prediction run that is selected in the prediction run list 1602. Execution details (e.g., for a selected prediction run that has been executed) can be displayed in response to selection of an execution details tab 1626.

The prediction run list 1602 includes information for displayed prediction runs. For example, the prediction run list 1602 includes, for each displayed prediction run, a status 1626, a run identifier 1628, a run description 1630, a scenario name 1632 associated with the prediction run, a model name 1634, a creation author 1636, and a creation time 1638.

Regarding prediction run statuses, when a prediction run is created and saved, the prediction run has a status of “In Preparation”. A prediction run with the status of “In Preparation” can be open and edited but not scheduled. When a prediction run is complete and ready for scheduling the status of the prediction run can be set to “Active”. A prediction run can be activated if the scenario for the prediction run has an active model. In some implementations, an active prediction run can't be edited. In some implementations, a prediction run with an “Active” status can be set to a status of “Obsolete”, but can't be changed back to a status of “In Preparation” or be deleted.

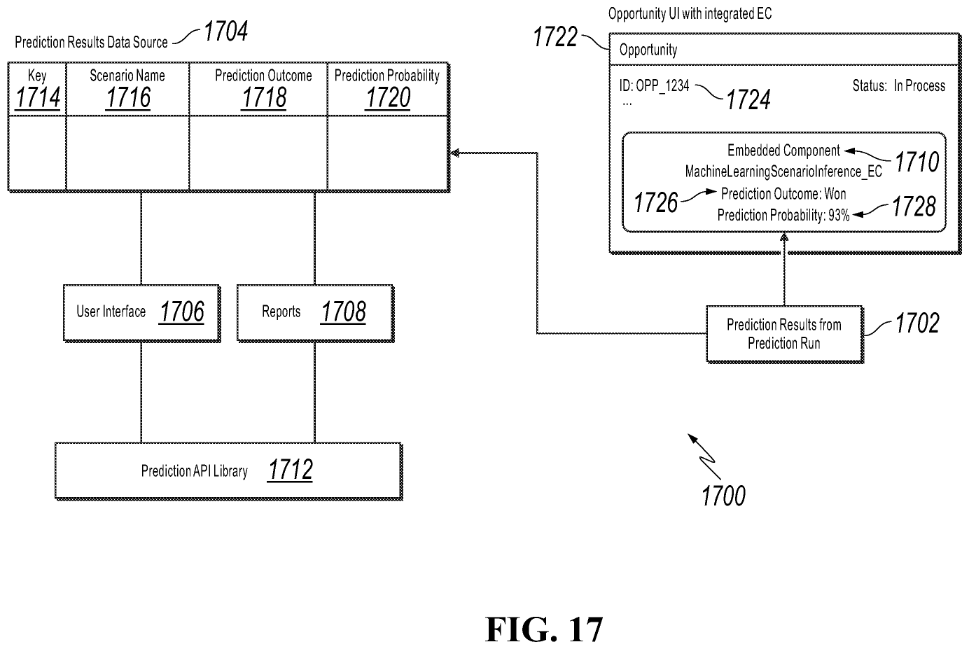

FIG. 17 is a diagram 1700 that illustrates consumption of a machine learning prediction. Predictions made by a prediction run job can persisted in internal data fields (e.g., of a table or an object) and can be subsequently consumed in different ways. For example, prediction results 1702 from a prediction run can be stored in a prediction results data source 1704 and then subsequently retrieved from the prediction results data source 1704 and used, for example, in a user interface 1706 and/or a report 1708. As another example, prediction results can be presented using a built-in (e.g., delivered) embedded component 1710. As yet another example, predictions can be also made and consumed programmatically (e.g., by partner developers) with the help of provided prediction API library 1712.

The prediction results data source 1704 can store results of predictions from all scenarios. A key field 1714 stores values of prediction dataset key fields. A scenario field 1716 stores names of scenarios for which respective predictions were made. A prediction outcome field 1718 stores values (e.g., predicted target field values) for scenario predictions. A prediction probability stores prediction percentages for predicted outcomes.

Regarding reports 1708, to display a prediction results in a context of other scenario data source fields, the prediction results data source 1704 can be joined with the scenario data source and used, for example, as a basis of a report 1708. For example, the prediction results data source 1704 can be joined with an opportunity header dataset, so that the report includes opportunity fields as well as a prediction outcome and prediction probability for one or more opportunities that are included in the report 1708. As such, reporting can easily be enhanced to include machine learning prediction information.

The embedded component 1710 is a ready-made user interface control that can be integrated with an application-object user interface, such as an opportunity user interface 1722. For example, the embedded component 1710 can display prediction results directly in an application-object instance user interface. For example, the opportunity user interface 1722 is displaying information for an opportunity instance with an instance identifier 1724 of OPP_1234. A prediction outcome portion 1726 and a prediction probability portion 1728 included in the embedded component 1710 display a prediction outcome of “Won” and a prediction probability of 93%, respectively, for the displayed opportunity instance. In some implementations, the embedded component 1720 includes a refresh button that enables the user to request regeneration of the prediction for the displayed instance on demand. For example, the user can request regeneration (or initial generation) of a prediction for a recently-modified object instance or a newly-created object instance, respectively.

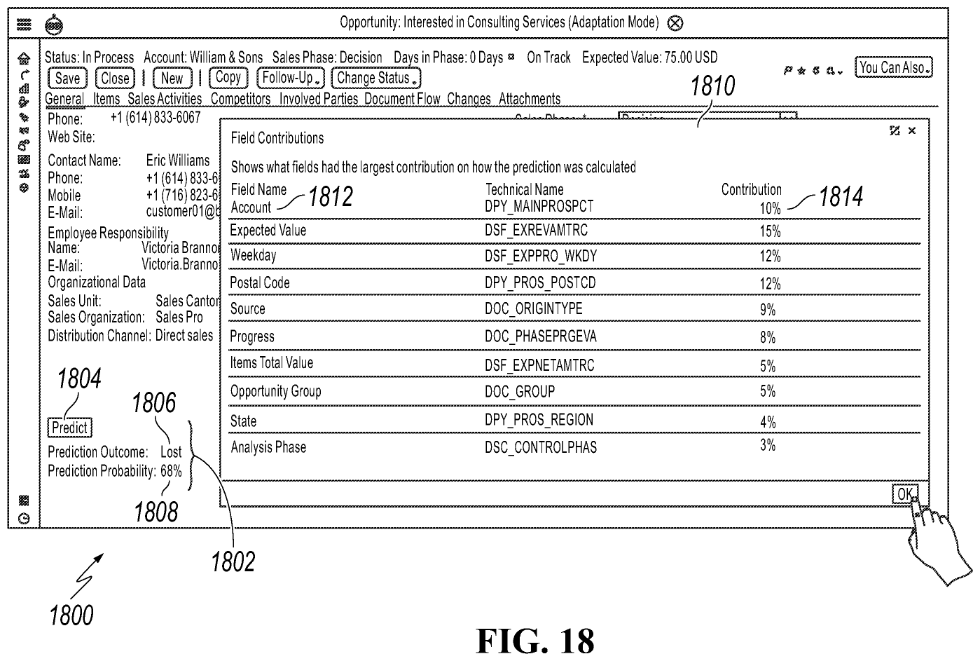

FIG. 18 is a user interface 1800 that illustrates consumption of a machine learning prediction. The user interface 1800 displays information for an opportunity object. The user interface 1800 has been customized to include a prediction widget 1802 that includes a predict button 1804, a prediction outcome 1806, and a prediction probability 1808. The prediction outcome 1806 and the prediction probability 1808 can be added to the user interface 1808 as extension fields, for example. The prediction outcome 1806 displays a last-generated prediction (e.g., “Lost”) for the displayed opportunity object from a prediction run. The prediction probability 1808 displays the generated prediction probability (e.g., 68%) for the prediction outcome 1806. The user can request regeneration of a prediction for the opportunity object by selecting the predict button 1804.

The prediction probability 1808 can be a selectable link. In response to selection of the prediction probability 1808, a field contribution popup 1810 can be displayed. The field contribution popup displays information that indicates which fields had a largest contribution towards the prediction outcome 1806. For example, an account field 1812 had an 18% contribution 1814 to the prediction outcome 1806. For example, the trained model used to generate the prediction may have learned that opportunities for the account stored in the account field have a certain tendency to be lost.

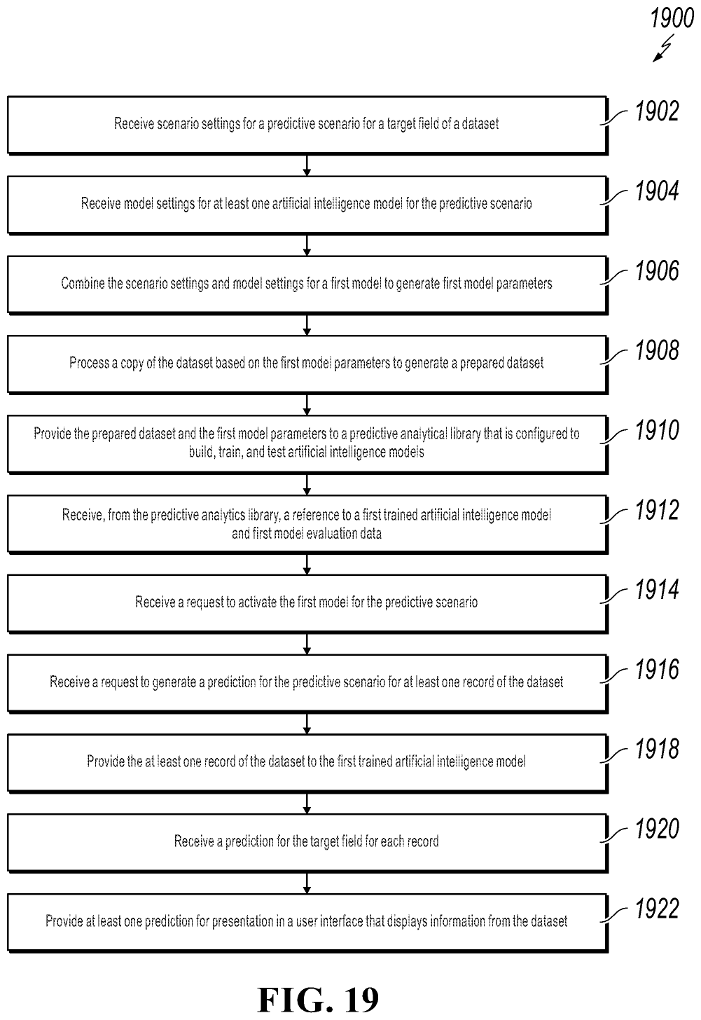

FIG. 19 is a flowchart of an example method 1900 for using an artificial intelligence work center for ERP data. It will be understood that method 1900 and related methods may be performed, for example, by any suitable system, environment, software, and hardware, or a combination of systems, environments, software, and hardware, as appropriate. For example, one or more of a client, a server, or other computing device can be used to execute method 1900 and related methods and obtain any data from the memory of a client, the server, or the other computing device. In some implementations, the method 1900 and related methods are executed by one or more components of the system 100 described above with respect to FIG. 1. For example, the method 1900 and related methods can be executed by the server 102 of FIG. 1.

At 1902, scenario settings are received for a predictive scenario for a target field of a dataset. The scenario settings can include a specification of the dataset and the target field, at least one filter condition for the target field, indications of fields of the dataset to include in training of artificial intelligence models of the predictive scenario, default data pre-processing settings (e.g., for null and/or outlier removal) for pre-processing the dataset before artificial intelligence models of the predictive scenario are trained, and/or default training settings for artificial intelligence models of the scenario. The default training settings can specify an artificial intelligence algorithm type, a specific artificial intelligence algorithm of the artificial intelligence algorithm type, and default parameters for the specific artificial intelligence algorithm. The default training settings can also include a data split configuration that indicates a split between a training portion of the dataset and a test portion of the dataset. The artificial intelligence models can be or include ML models or other types of AI models. The artificial intelligence algorithms can be or include ML algorithms or other types of AI algorithms.

At 1904, model settings are received for at least one artificial intelligence model for the predictive scenario.

At 1906, the scenario settings and model settings are combined for a first model to generate first model parameters for the first model. Combining can include determining that the model settings for the first model include at least one modification to a corresponding scenario setting and including the at least one modification in the first model parameters. Combining can include combining filter conditions from the scenario settings with other filter conditions included in the model settings for the first model. The at least one modification to a corresponding scenario setting includes a model-specific setting for nulls removal, a model-specific setting for outlier removal, a model-specific algorithm parameter, a model-specific data split configuration, and/or a model-specific filter condition that is to be added to a filter condition of the predictive scenario.

At 1908, a copy of the dataset is processed based on the first model parameters to generate a prepared dataset. Generating the prepared dataset can include pre-processing the dataset based on data pre-processing settings in the first model, filtering the dataset based on filter conditions in the first model parameters, and splitting the copy of the dataset into a training portion and a test portion based on a data split configuration in the first model parameters.

At 1910, the prepared dataset and the first model parameters are provided to a predictive analytical library that is configured to build, train, and test artificial intelligence models.

At 1912, a reference to a first trained artificial intelligence model and first model evaluation data is received from the predictive analytical library. The first trained artificial intelligence model is trained by the predictive analytical library based on the prepared dataset and the first model parameters. The first model evaluation data reflects model performance of the first model for predicting the target field of the dataset.

At 1914, a request is received to activate the first model for the predictive scenario. The request to activate the first model can be based on a comparison (e.g., automated or manual comparison) of the first model evaluation data to model evaluation data of at least one other model of the predictive scenario.

At 1916, a request is received to generate a prediction for the predictive scenario for the target field for at least one record of the dataset.

At 1918, the at least one record of the dataset is provided to the first trained artificial intelligence model.

At 1920, a prediction for the target field is received from the first trained artificial intelligence model for each record of the at least one record of the dataset. Each prediction of the target field can include a predicted outcome of the target field and a prediction probability for the predicted outcome. Additionally, for each prediction, field contribution data can be received from the predictive analytics library that indicates which fields of the dataset most contributed to the prediction.

At 1922, at least one prediction is provided for presentation in a user interface that displays information from the dataset. The user interface can be modified to display prediction outcomes and prediction probabilities, for example.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving scenario settings for a predictive scenario for a target field of a dataset;
receiving model settings for at least one artificial intelligence model for the predictive scenario; and
for a first model of the at least one artificial intelligence model:
combining the scenario settings and model settings for the first model to generate first model parameters for the first model;
processing a copy of the dataset based on the first model parameters to generate a prepared dataset;
providing the prepared dataset and the first model parameters to a predictive analytical library that is configured to build, train, and test artificial intelligence models;
receiving, from the predictive analytics library, a reference to a first trained artificial intelligence model trained by the predictive analytical library based on the prepared dataset and the first model parameters and first model evaluation data that reflects model performance of the first model for predicting the target field of the dataset;
receiving a request to activate the first model for the predictive scenario;
receiving a request to generate a prediction for the predictive scenario for the target field for at least one record of the dataset;
providing the at least one record of the dataset to the first trained artificial intelligence model;
receiving, from the first trained artificial intelligence model, a prediction for the target field for each record of the at least one record of the dataset; and
providing at least one prediction for presentation in a user interface that displays information from the dataset.

2. The computer-implemented method of claim 1, wherein the first trained artificial intelligence model is a trained machine learning model.

3. The computer-implemented method of claim 1, wherein the scenario settings include a specification of the dataset and the target field.

4. The computer-implemented method of claim 1, wherein the scenario settings include at least one filter condition for the target field.

5. The computer-implemented method of claim 1, wherein the scenario settings include indications of fields of the dataset to include in training of artificial intelligence models of the predictive scenario.

6. The computer-implemented method of claim 1, wherein the scenario settings include default data pre-processing settings for pre-processing the dataset before artificial intelligence models of the predictive scenario are trained.

7. The computer-implemented method of claim 6, wherein the default data pre-processing settings includes settings for removal of outlier values and null values from the dataset.

8. The computer-implemented method of claim 1, wherein the scenario settings include default training settings for artificial intelligence models of the scenario.

9. The computer-implemented method of claim 8, wherein the default training settings specify an artificial intelligence algorithm type and a specific artificial intelligence algorithm of the artificial intelligence algorithm type and wherein the default training settings specify default parameters for the specific artificial intelligence algorithm.

10. The computer-implemented method of claim 8, wherein the default training settings include a data split configuration that indicates a split between a training portion of the dataset and a test portion of the dataset.

11. The computer-implemented method of claim 1, wherein each model of the at least one artificial intelligence model is trained to predict values of the target field.

12. The computer-implemented method of claim 1, wherein combining the scenario settings and model settings for the first model comprises:
determining that the model settings for the first model include at least one modification to a corresponding scenario setting; and
including the at least one modification in the first model parameters.

13. The computer-implemented method of claim 12, wherein the at least one modification to a corresponding scenario setting includes a model-specific setting for nulls removal, a model-specific setting for outlier removal, a model-specific algorithm parameter, a model-specific data split configuration, or a model-specific filter condition that is to be added to a filter condition of the predictive scenario.

14. The computer-implemented method of claim 1, wherein a first model-specific setting for the first model is different from a second model-specific setting for a second model of the predictive scenario.

15. The computer-implemented method of claim 1, wherein generating the prepared dataset comprises pre-processing the dataset based on data pre-processing settings in the first model, filtering the dataset based on filter conditions in the first model parameters, and splitting the copy of the dataset into a training portion and a test portion based on a data split configuration in the first model parameters.

16. The computer-implemented method of claim 1, wherein the request to activate the first model is based on a comparison of the first model evaluation data to model evaluation data of at least one other model of the predictive scenario.

17. The computer-implemented method of claim 1, wherein each prediction of the target field includes a predicted outcome of the target field and a prediction probability for the predicted outcome.

18. The computer-implemented method of claim 1, further comprising receiving, from the predictive analytics library for a first prediction, field contribution data that indicates which fields of the dataset most contributed to the first prediction.

19. A system comprising:
one or more computers; and
a computer-readable medium coupled to the one or more computers having instructions stored thereon which, when executed by the one or more computers, cause the one or more computers to perform operations comprising:
receiving scenario settings for a predictive scenario for a target field of a dataset;
receiving model settings for at least one artificial intelligence model for the predictive scenario; and
for a first model of the at least one artificial intelligence model:
combining the scenario settings and model settings for the first model to generate first model parameters for the first model;
processing a copy of the dataset based on the first model parameters to generate a prepared dataset;
providing the prepared dataset and the first model parameters to a predictive analytical library that is configured to build, train, and test artificial intelligence models;
receiving, from the predictive analytics library, a reference to a first trained artificial intelligence model trained by the predictive analytical library based on the prepared dataset and the first model parameters and first model evaluation data that reflects model performance of the first model for predicting the target field of the dataset;
receiving a request to activate the first model for the predictive scenario;
receiving a request to generate a prediction for the predictive scenario for the target field for at least one record of the dataset;
providing the at least one record of the dataset to the first trained artificial intelligence model;
receiving, from the first trained artificial intelligence model, a prediction for the target field for each record of the at least one record of the dataset; and
providing at least one prediction for presentation in a user interface that displays information from the dataset.

20. A computer program product encoded on a non-transitory storage medium, the product comprising non-transitory, computer readable instructions for causing one or more processors to perform operations comprising:
receiving scenario settings for a predictive scenario for a target field of a dataset;
receiving model settings for at least one artificial intelligence model for the predictive scenario; and
for a first model of the at least one artificial intelligence model:
combining the scenario settings and model settings for the first model to generate first model parameters for the first model;
processing a copy of the dataset based on the first model parameters to generate a prepared dataset;
providing the prepared dataset and the first model parameters to a predictive analytical library that is configured to build, train, and test artificial intelligence models;
receiving, from the predictive analytics library, a reference to a first trained artificial intelligence model trained by the predictive analytical library based on the prepared dataset and the first model parameters and first model evaluation data that reflects model performance of the first model for predicting the target field of the dataset;
receiving a request to activate the first model for the predictive scenario;
receiving a request to generate a prediction for the predictive scenario for the target field for at least one record of the dataset;
providing the at least one record of the dataset to the first trained artificial intelligence model;
receiving, from the first trained artificial intelligence model, a prediction for the target field for each record of the at least one record of the dataset; and
providing at least one prediction for presentation in a user interface that displays information from the dataset.
